(19) United States
(12) Patent Application Publication
(10) Pub. No.: US 2009/0097695 A9
(43) Pub. Date: Apr. 16, 2009

(54) Personal document authentication system using watermarking

(76) Inventor: Geoffrey B. Rhoads, West Linn, OR (US)

Correspondence Address: DIGIMARC CORPORATION, 9405 SW GEMINI DRIVE, BEAVERTON, OR, 97008, US

(21) Appl. No.: 10/326,575

(22) Filed: Dec. 20, 2002

Related U.S. Application Data
(63) Continuation-in-part of application No. 09/837,564, filed on Apr. 17, 2001, now abandoned.
(63) Continuation-in-part of application No. 10/011,129, filed on Nov. 9, 2001, now Pat. No. 6,970,573.
Application No. 10/011,129 is a continuation of application No. 09/442,780, filed on Nov. 18, 1999, now Pat. No. 6,389,151.
(63) Continuation-in-part of application No. 09/198,022, filed on Nov. 23, 1998, now Pat. No. 6,546,112.
Application No. 09/198,022 is a continuation of application No. 08/763,847, filed on Dec. 4, 1996, now Pat. No. 5,841,886.
Application No. 08/763,847 is a continuation of application No. 08/512,993, filed on Aug. 9, 1995, now abandoned.
Application No. 08/512,993 is a continuation-in-part of application No. 08/436,098, filed on May 8, 1995, now Pat. No. 5,636,292.
Application No. 08/512,993 is a continuation-in-part of application No. 08/436,099, filed on May 8, 1995, now Pat. No. 5,710,834.
Application No. 08/512,993 is a continuation-in-part of application No. 08/436,134, filed on May 8, 1995, now Pat. No. 5,748,763.
Application No. 08/512,993 is a continuation-in-part of application No. 08/438,159, filed on May 8, 1995, now Pat. No. 5,850,481.
(60) Provisional application No. 60/198,138, filed on Apr. 17, 2000.
(60) Provisional application No. 60/198,849, filed on Apr. 21, 2000.
(60) Provisional application No. 60/109,259, filed on Nov. 19, 1998.

(51) Int. Cl. G06K 9/00; H04L 9/00; G06K 9/36

(52) U.S. Cl. 382/100; 382/232

(57) ABSTRACT

An identification document includes a unique identifier, and a picture of a person. Steganographically embedded in the picture is information corresponding to the identifier, by which the document can be authenticated. A verification apparatus reads the identifier from the document (e.g., by OCR or a machine-readable feature), and collects scan data corresponding to the picture. The scan data is processed to extract the embedded information. The embedded information is then compared for expected correspondence with the identifier. A remote database can store information related to the card, and can be queried in connection with the authentication.

### RELATED APPLICATION DATA

The present application is a continuation in part of each of the following copending applications:
Ser. No. 09/837,564, filed Apr. 17, 2001, which claims priority to Ser. No. 60/198,849, filed Apr. 21, 2000 and Ser. No. 60/198,138, filed Apr. 17, 2000;
Ser. No. 10/011,129, filed Nov. 9, 2001, which is a continuation of Ser. No. 09/442,780, filed Nov. 18, 1999 (now U.S. Pat. No. 6,389,151), which claims priority to Ser. No. 60/109,259 filed Nov. 19, 1998;
Ser. No. 09/198,022 (allowed), filed Nov. 23, 1998, which is a continuation of Ser. No. 08/763,847, filed Dec. 4, 1996 (now U.S. Pat. No. 5,841,886), which is a continuation of Ser. No. 08/512,993, filed Aug. 9, 1995, now abandoned.

Priority to each of these prior applications is claimed. Each of these prior applications is incorporated herein by reference.

### FIELD OF THE INVENTION

The present invention relates to systems using watermarking in connection with issuing personal documents (e.g., identification cards), and for authenticating such documents.

### BACKGROUND AND SUMMARY OF THE INVENTION

Many security documents contain a picture of the owner of the document. For example, a driver's license generally includes a picture of the driver and a passport generally includes a picture of the owner of the passport. Validation of such documents is performed by comparing the actual physical appearance of the person possessing the document to the picture on the document. A common counterfeiting techniques involves replacing the picture on a security document with a picture of someone who is not the owner of the document.

U.S. Pat. No. 5,841,886 describes a technique whereby a digital watermark is included in the picture on a security document.

The security document contains human readable text that is related to the data contained in the watermark. The document can be inserted into a scanner which will read the watermark and the operator can compare the output of watermark reader to the text to insure that the person possessing the document is the legitimate owner.

Custom printing systems are available which accept data from multiple sources and which produce documents which are tailored to individual customer characteristics or to information concerning an individual customer. Such systems can for example produce personalized documents that include both fixed information that is on each document that is printed and variable information such as personal information about an individual's account at an institution such as a bank. One such system is commercially marketed under the trademark “PageFlex” by Bitstream Inc. or Cambridge Mass.

Likewise the technology for producing images which contain steganographic information in the form of digital watermarks is well developed. For example see U.S. Pat. Nos. 5,636,292, 5,748,783 or the “Communications of the ACM” published July 1998 Vol. 41. No. 7 pages 31 to 77. Commercial products which can store and read digital watermarks are also widely available. Examples of such products include “Adobe PhotoShop” Versions 4.0 and 5.0 and “Adobe ImageReady” Version 1.0 which are marketed by Adobe Corporation, “CorelDRAW” Versions 7 and 8, and “Corel PHOTO-PAINT” Versions 7 and 8 which are marketed by Corel Corporation, and Micrografx Webtricity” Versions 1 and 2, “Micrografx Graphics Suite 2”, and “Micrografx Picture Publisher” Versions 7 and 8 which are marketed by Micrografx Corporation.

Security documents such as passports and drivers licenses have traditionally contained both images and printed text. However, the images and the text in such documents are generally prepared in separate processes and merely merged at a final step in the overall production.

In one aspect the present invention relates to an improved security document which has several correlated multi-level self validating features. In another aspect, the present invention relates to an improved overall method and system for producing security documents and to automatic authentication systems for such documents. Such ae document contains a number of different kinds of information that is hidden from normal view and can be correlated to validate the document. The validation can be done entirely automatically decreasing the need for human intervention.

The foregoing and other features and advantages of the present invention will be more readily apparent from the following detailed description, which proceeds with reference to the accompanying drawings.

### BRIEF DESCRIPTION OF THE DRAWINGS

FIG. 1 illustrates a security document in accordance with the present invention.

FIG. 2 is an overall diagram of a preferred embodiment of a system to produce security documents in accordance with the present invention.

FIG. 3 is a diagram of a document validation system that operates in accordance with the present invention.

### DETAILED DESCRIPTION

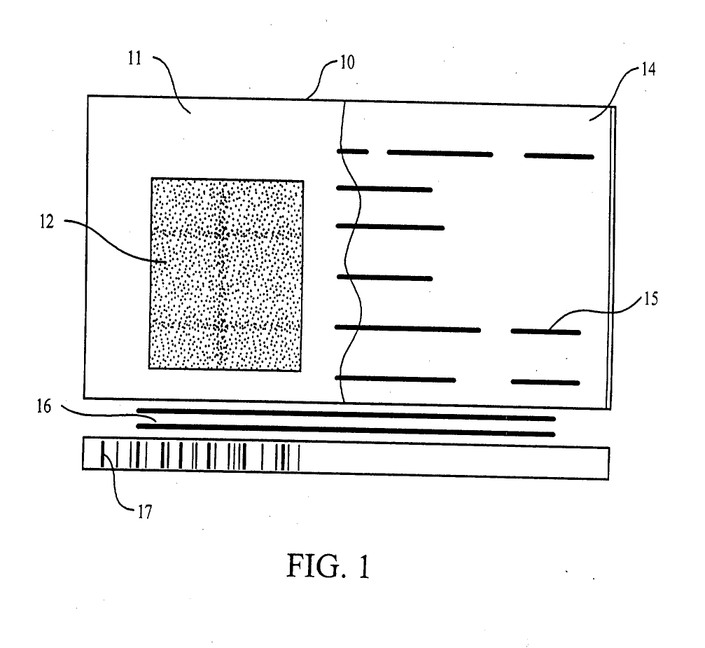

A diagram of a security document in accordance with the present invention is shown in FIG. 1. The security features on the document are a pre-printed background 11 which has an image or pattern (not visible in FIG. 1) which contains a digital watermark. The image in background 11 may contains lines the width of which are varied to carry a watermark in accordance with the technique described in co-pending application Ser. No. 09/074034 filed May 6, 1998, the disclosure of which in incorporated herein in its entirety.

The document also contains a photograph 12 which shows the owner of the document. This photograph 12 contains a watermark such as that described in U.S. Pat. No. 5,841,886 which will issue Nov. 24, 1998. The personalized background 14 can for example be a background image which corresponds to the image 12. While the personalized image 14 corresponds to the photograph 12, in area 14 the image is printed as a background image. Background images of various types are conventional, for example personal checks frequently have background images of animals, mountains, etc. The background text makes it hard to change the human readable text 15 which is printed over the background text. The bottom of the document has machine readable OCR-B text 16 and a Bar code 17.

It should be clearly understood that the document shown in FIG. 1 is merely illustrative of the various elements that can be combined to form a security document. The exact layout can vary depending upon the needs of the particular application. If desired for a particular application, the document can be much more complex than the document shown in FIG. 1. The document can have many more fields and elements than does the document shown in FIG. 1. Furthermore the document could contain the various other known technology for preventing counterfeiting such as special paper and special ink.

Document shown in FIG. 1 can for example be a document such as a driver's license in which case the picture 12 would be a picture of the owner of the license. Graphic image 11 could for example be a state seal. The text 15 could for example include the driver's license number, the owners age, and the owners address.

Document 10 can be a passport. In a passport, the hidden digital watermark data in picture 12 and in the other fields could be coordinated as follows:

| | Watermark contains | Correlates to |
|---|---|---|
| Pre-printed | unique document “batch” number | |
| background 11 | | |
| Photo 12: | Batch number and passport | OCR-B version of |
| | number | passport number, |
| | (cryptographically encoded) | Human readable |
| | | passport number, |
| | | Master |
| | | document |
| Personalized | “hash” of fingerprint | fingerprint of |
| background 14 | | the holder |
| | | which is |
| | | automatically read |
| Bar code 17 | Passport number | Watermark in photo |
| | (in code not in watermark) | 12 |
| OCR-B text 16 | Passport number Batch number | Info in photo 12, |
| | (in text not in watermark) | background 11 |
| | | And Bar code 17 |

The various elements of hidden and visual information are coordinated in such a manner that the document is self authenticating. The hidden data in one field can be correlated with the hidden data in another field to insure that the document has not been altered.

If for example one tried to alter a document by replacing picture 12 with a different picture, the new picture would either contain no hidden data, or if it were a picture taken from a different document, the numbers stored in the picture would not match the printed information in text field 15.

If the picture from one document were substituted for the picture in a second document, the cryptographically encoded serial numbers could be used to determine the origin of the picture. It is noted that while in the example shown above, both the Batch number and passport number are cryptographically encoded, other numbers such as a serial number or an ID number could also be encoded in a special manner.

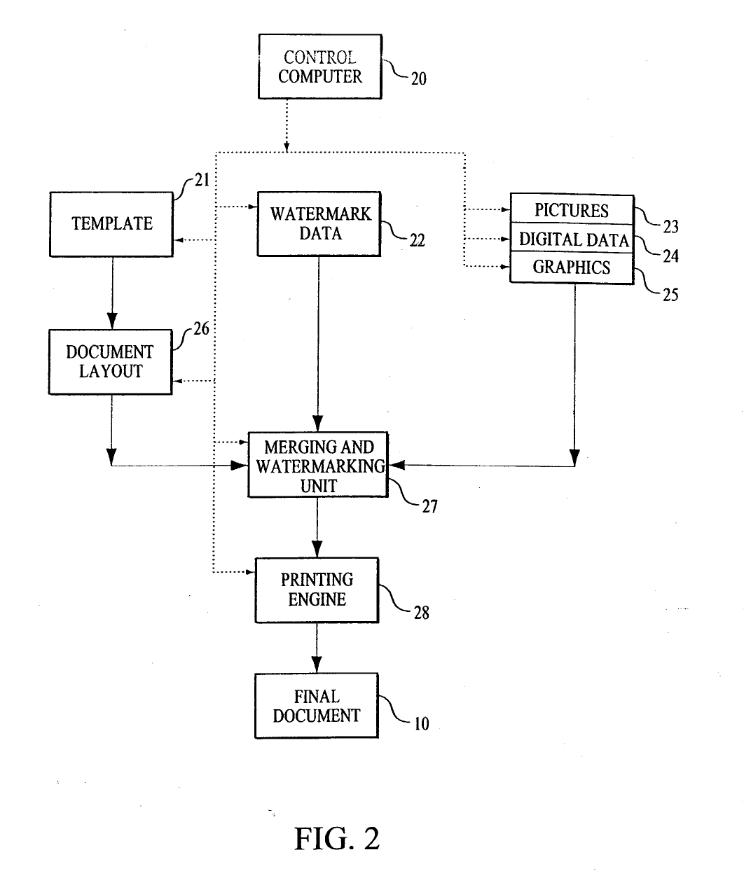

FIG. 2 shows an overall diagram of a system for producing document 10. The system includes a number of units, the operation of which is controlled and coordinated by a control computer 20. The following explanation will illustrate how the embodiment shown in FIG. 2 can be used to produce a document such as the document shown in FIG. 1.

A template 21 is used to define the overall characteristics of a document. The characteristics specified by template 21, including the fields on the document, the data printed in any text fields and the watermarks included in each image included on the document.

The template 21 is used by document layout device 26 to layout a particular document for production. Data which is to be included in the watermarks in any image field are stored in Watermark data store 22. Any pictures, text data, and Graphics are stored in units 23, 24 and 25 respectively.

The document layout from unit 26, the digital watermark data from unit 22 and the pictures, text data and graphics from units 23, 24, and 25 are sent to Merging and watermarking unit 27. Unit 27 applies watermarks to pictures and graphics as specified by the layout information from unit 11. Application of the watermarks to the pictures and graphics can be done in a conventional manner; however, prior to sending the watermark payload (i.e. the data stored in the watermark) to the watermarking engine, the data can be passed through a conventional encryption program. Encrypting the payload data provides an added assurance that a counterfeiter could not make a counterfeit document. The level of encryption could be any level appropriate tot he value of the document.

The output from the Merging and watermarking unit 27 is then sent to a conventional printing engine 28 which produces a final document 10.

Watermark Data storage 22, picture storage 23, digital data storage 24 and graphics storage 25 can be conventional data storage servers. Physically they could all be provided by one physical storage unit. Template input unit 21 is a conventional interactive terminal or personal computer with a graphic design program. Merging and watermarking unit 27 can be a conventional watermarking engine.

The system shown in FIG. 2 produces various parts of the security document in a single step, thereby making it much harder to replace one element on a security document with a similar element from another document.

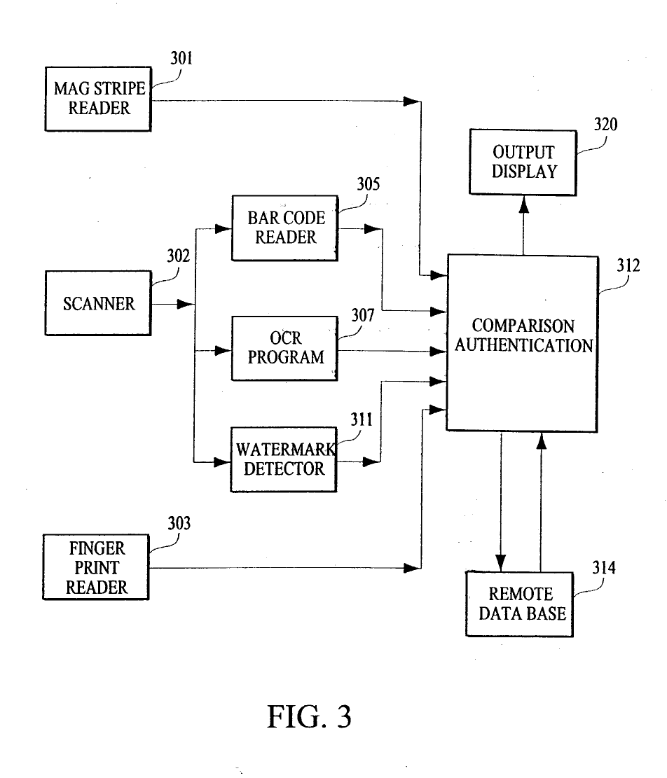

FIG. 3 is a diagram of a document self authentication unit in accordance with the present invention. The system has three input units, each of which is conventional and commercially available. The input units are a magnetic stripe reader 301, a high resolution image scanner 302, and a fingerprint reader 303. The document 10, shown in FIG. 1 does not include a magnetic stripe, but one of the alternatives for such a document is to include a magnetic stripe.

The output from scanner 305 goes to three units (that is, to three computer programs) 305, 307 and 311. Alternatively, the bar code reader 305 could be a separate unit which directly reads the bar code and provides information to comparison and authentication unit 312.

If the bar code reader 305 is a computer program which receives information from the output of scanner 302, The program 305 will read the bar code 17. OCR program 307 reads the text 15 and the text 16 and watermark detector 311 reads the watermarks in images 11, 12 and 14.

An authentication and comparison unit 312 which compares the data from units 305, 307 311 and 303 to determine if the data matches. If the data in some of the watermarks is encrypted, the comparison and authentication unit 312 would include an appropriate decryption program. The decryption program in unit 312 could obtain the decryption key from remote data base 314 in response to the number read by one of the devices. Alternatively, the encrypted data could be automatically sent to a central facility for decryption. The unit 312 can also access a remote data base 314 to determine if there is any special handling that is required for the document that has been presented. For example data base 314 could contain information about passports that have been cancelled for various reasons. The resulting information is displayed on a display unit 320.

In another embodiment, content specific attributes of a watermark derived at the time of encoding are used to authenticate the watermark in the decoding process. After the encoder has completed encoding a watermark into an object, it analyzes the watermarked object and derives a characteristic or set of characteristics that describe attributes of it. This attribute can be a characteristic signal manifested in a transform domain or in the native domain of the watermarked signal. For example, the attribute may be the location or location of frequency coefficients that have signal energy above a given level. It may be an identifier of a color and a corresponding range of watermark signal strength in that color. For an image object, this characteristic may be measured by printing the watermarked image, scanning the image back to a digital domain, and then computing the characteristic. Next, the characteristic is stored in a database entry that is referenced via a database index in the watermark message. At decoding time, the characteristic is re-computed by scanning the watermarked image. The characteristic computed at decoding time is then matched with the characteristic stored in the database to determine whether it is sufficiently close to the stored characteristic. If so, it is deemed valid; otherwise, it is rejected.

In other embodiments, on the issuing side, a watermark encoder embeds a digital watermark in a digital photo (or other image to be placed on the ID document). The watermark carries a piece of multi-bit identifying data. This data can optionally link to data on the card.

Preferably, the embedding process is tuned for survival through printing and scanning. A detailed description of such a process is provided in U.S. patent application Ser. No. 09/503,881.

The watermark encoder also embeds in a second version of the digital photo the same piece of identifying data. The second image may be compressed with a technique such as JPEG still image compression, or optionally down-sampled to reduce storage requirements. The processes of down-sampling and compression may be used together or singly. The embedding process in the second image may be less tuned to maintain image quality and more tuned to survive manipulation such as image compression, down-sampling, or other transformation that it will undergo.

The first image is printed on the identification document (e.g., ID card) using personalized printing methods that could range from ink-jet printing to laser engraving.

The second image is encoded on the identification document in some portable storage media device or machine readable code such as a magnetic stripe, a 2D barcode, transistor, RF tag, magnetic ink, etc.

Alternatively, it is encoded in a database accessible to ID document inspection systems. In such case, the ID document is linked to the second image via an identifier that serves as a database key to a database entry storing the second image. The inspection system may be equipped with the database as well as a database manager for retrieving images via their respective keys. Alternatively, it may access the database through a wire or wireless connection using standard network communication protocols (e.g., via a network connection, which may include a wire and/or wireless connection). The identifier may be embedded in the ID document in a watermark or some other storage device or machine readable code, such as the examples listed above.

I Claim

1. An authentication system comprising: a database for storing an identifier of a personal document and digital watermark information related to said identifier; a personal document containing said identifier; said personal document also containing a readable authentic image in which a digital watermark relative to said identifier is embedded; a read means for reading at least said authentic image from said personal document; a watermark information inquiring means for extracting digital watermark information corresponding to said identifier from said authentic image; and a watermark information comparing means for judging whether said digital watermark information extracted by said watermark information inquiring means from said personal document is identical to said watermark information stored in said database; if said watermark inquiring means finds identical watermark information in said watermark information from said authentic image and said database, said watermark inquiring means justifies said personal document; and if the watermark information from the two sources are not identical then the watermark inquiring means fails to justify said personal document.

2. The authentication system of claim 1, wherein said personal document includes: an information carrier for storing said authentic image; and said digital watermark is embedded in said authentic image stored in said information carrier.

3. The authentication system of claim 2, wherein said information carrier is at least one of a semiconductor memory and a magnetic recording material.

4. The authentication system of claim 2, wherein: said information carrier includes said authentic image being a printed authentic image affixed to said personal document; and said read means reads said printed image.

5. The authentication system of claim 1, wherein at least one of said identifier and said digital watermark information includes an element that is randomly generated.

6. The authentication system of claims 1, further comprising: means for updating said digital watermark information stored in said database and said digital watermark information embedded in said authentic image in said personal document each time said watermark information inquiring means judges said digital watermark information to be justifiable.

7. The authentication system of claim 1, further comprising: a communication device for communicating said watermark information between said watermark information inquiring means and said database.

8. A personal document issuing system comprising: an identifier generating means for generating an identifier unique to a personal document; a watermark information generating means for generating digital watermark information corresponding to said identifier; a database for storing said identifier of said personal document and said digital watermark information relative to said identifier in relation to each other; a watermark information registering means for storing said identifier generated by said identifier generating means and said digital watermark information generated by said watermark information generating means in said database; an image input means for inputting a raw authentic image; a watermark-embedded image forming means for forming a watermark-embedded authentic image in which said digital watermark is embedded on said authentic image input by said image input means; and a personal document that readably carries said authentic image generated by said watermark-embedded image forming means and said identifier generated by said identifier generating means.

9. The personal document issuing system of claim 8, wherein: said personal document includes an information carrier for storing said authentic image; and said authentic image includes a digital watermark embedded in said authentic image stored in said information carrier.

10. The personal document issuing system of claim 9, wherein said information carrier is at least one of a semiconductor memory and a magnetic material.

11. The personal document issuing system of claim 9 wherein: said information carrier includes said authentic image being a printed authentic image affixed to said personal document; and said read means reads said printed authentic image.

12. The personal document issuing system of claim 8, wherein at least one of said identifier and said digital watermark information includes an element that is randomly generated.

13. The personal document issuing system of claim 8, wherein said digital watermark information stored in said database and embedded in said authentic image of said personal document are updated at a predetermined time.

14. The personal document issuing system of claim 13, wherein said predetermined time includes each time said system correctly justifies an authentic image.

15. The personal document issuing system of claim 8, further comprising: a communication device for communicating said watermark information between said watermark information inquiring means and said database.

16. A personal document comprising: a unique identifier; an authentic image of an authorized user of said personal document; said authentic image being viewable by eye; said authentic image containing embedded therein digital watermark information corresponding to said identifier; and means for permitting communication of said identifier and said digital watermark information to a database remote from said personal document.
